(19) United States
(12) Patent Application Publication
(10) Pub. No.: US 2024/0362713 A1
(43) Pub. Date: Oct. 31, 2024

(54) SERVER-CLIENT SKILLED TRADES COMMUNICATION SYSTEM

(71) Applicant: THE CONSTRUCTION PLATFORM, LLC, VALRICO, FL (US)

(72) Inventors: Joseph Louis Russo, VALRICO, FL (US); Michael Bevier Knight, VALRICO, FL (US)

(21) Appl. No.: 18/646,470

(22) Filed: Apr. 25, 2024

Related U.S. Application Data
(60) Provisional application No. 63/498,502, filed on Apr. 26, 2023.

(51) Int. Cl. G06Q 40/04

(52) U.S. Cl. CPC G06Q 40/04

(57) ABSTRACT

A system that includes a computer is described. The computer includes a processor and a memory. The memory includes instructions such that the processor is programmed to receive data corresponding to at least one of a bid request or a labor request and determine a trades group corresponding to the at least one of the bid request or the labor request. The memory further includes instructions such that the processor is programmed to generate a post displaying information corresponding to the at least one of the bid request or the labor request within a news feed corresponding to the trades group.

### BACKGROUND

Social networks websites have recently grown in popularity to become some of the most visited websites on the Internet. Typically, users of a social network website can communicate with each other and share posts only on that social network website.

### BRIEF DESCRIPTION OF THE DRAWINGS

FIG. 1 is a diagram of an example system for providing access to a skilled trades communication system within a computing environment.

FIG. 2 is a diagram of an example client device.

FIG. 3A is a diagram of another example system for providing access to a skilled trades communication system within a computing environment.

FIG. 3B is a diagram illustrating an example deep neural network.

FIG. 4 is a graphical representation of a webpage including information elements pertaining to the skilled trades communication system.

FIG. 5 is a graphical representation of a webpage corresponding to the skilled trades communication system presented to a user via a client device.

FIG. 6 is a graphical representation of a webpage corresponding to the skilled trades communication system presented to a user via a client device.

FIG. 7 is a graphical representation of a webpage corresponding to the skilled trades communication system presented to a user via a client device.

FIG. 8A is a graphical representation of a webpage corresponding to the skilled trades communication system presented to a user via a client device.

FIG. 8B is a graphical representation of a webpage corresponding to the skilled trades communication system presented to a user via a client device.

FIG. 9 is a graphical representation of a webpage corresponding to the skilled trades communication system presented to a user via a client device.

FIG. 10 is a graphical representation of a webpage corresponding to the skilled trades communication system presented to a user via a client device.

FIG. 11 is a flow diagram illustrating a process for associating at least a first user profile with a second user profile based on a request using a deep neural network.

### DETAILED DESCRIPTION

The present disclosure describes a server-client communication system that allows users to connect with one another. In various implementations, the users include individuals belonging to and/or comprising skilled labor and/or tradesmen. As discussed herein, users can access features of the server-client communication system to generate user profiles, populate the user profiles with relevant licensing and/or certifications, access a news feed related to construction and/or skilled trades, and the like. Users can also be connected with other users based on the relevant licensing and/or certifications as discussed in greater detail herein.

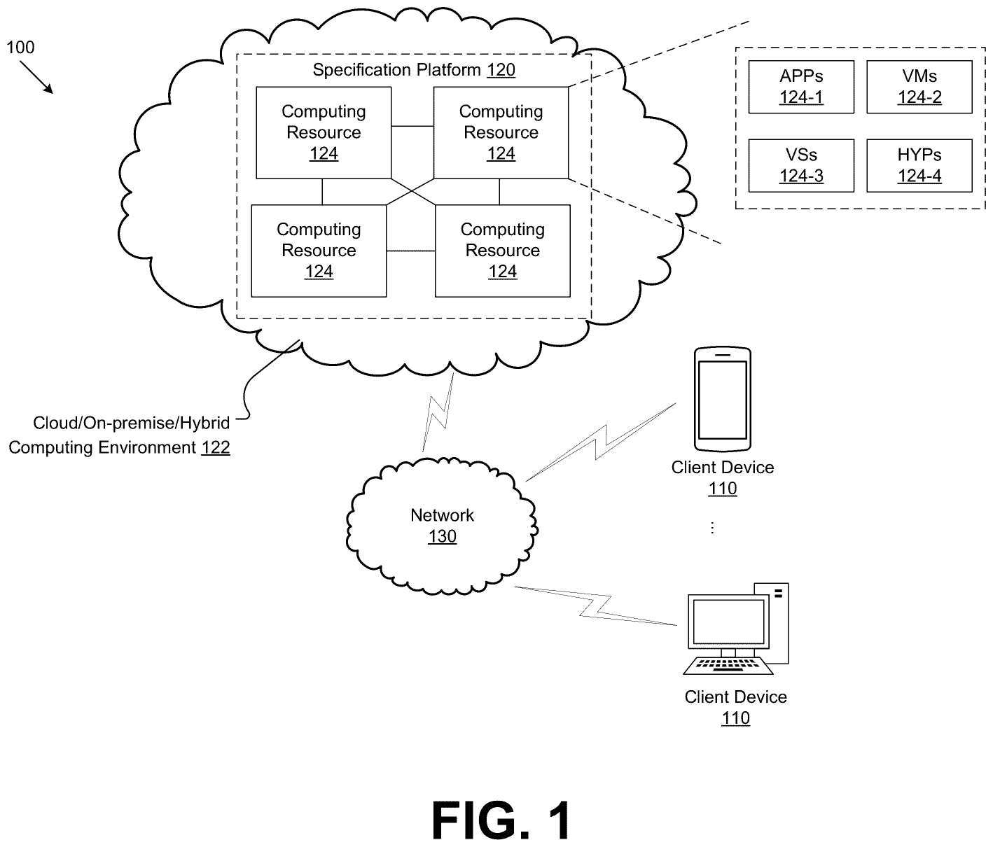

FIG. 1 illustrates an example environment 100 that includes one or more client devices 110, a specification platform 120, and a network 130, and a server device 140. Devices of environment 100 may interconnect via wired connections, wireless connections, or a combination of wired and wireless connections.

Client device 110 includes one or more devices capable of receiving, generating, storing, processing, and/or providing information associated with an account and/or a transaction for which the account is to be used. For example, client device 110 may include a desktop computer, a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), or a similar type of device.

Specification platform 120 includes one or more devices that authorize client devices 110 and provide access to an intranet and/or selected extranets after authorization of client devices 110. In some implementations, specification platform 120 may be designed to be modular such that certain software components may be swapped in or out depending on a particular need. As such, specification platform 120 may be easily and/or quickly reconfigured for different uses. In some implementations, specification platform 120 may receive information from and/or transmit information to one or more client devices 110 and/or server devices 140.

In some implementations, as shown, specification platform 120 may be hosted in a cloud computing environment 122, an on-premise computing environment, a hybrid (e.g., on-premise and cloud-based) computing environment, and/or the like. Notably, while implementations described herein describe specification platform 120 as being hosted in cloud computing environment 122, in some implementations, specification platform 120 may not be cloud-based (i.e., may be implemented outside of a cloud computing environment) or may be partially cloud-based.

Cloud computing environment 122 includes an environment that hosts specification platform 120. Cloud computing environment 122 may provide computation, software, data access, storage, etc., services that do not require end-user knowledge of a physical location and configuration of system(s) and/or device(s) that hosts specification platform 120. As shown, cloud computing environment 122 may include a group of computing resources 124 (referred to collectively as “computing resources 124” and individually as “computing resource 124”).

Computing resource 124 includes one or more personal computers, workstation computers, mainframe devices, or other types of computation and/or communication devices. In some implementations, computing resource 124 may host specification platform 120. The cloud resources may include compute instances executing in computing resource 124, storage devices provided in computing resource 124, data transfer devices provided by computing resource 124, etc. In some implementations, computing resource 124 may communicate with other computing resources 124 via wired connections, wireless connections, or a combination of wired and wireless connections.

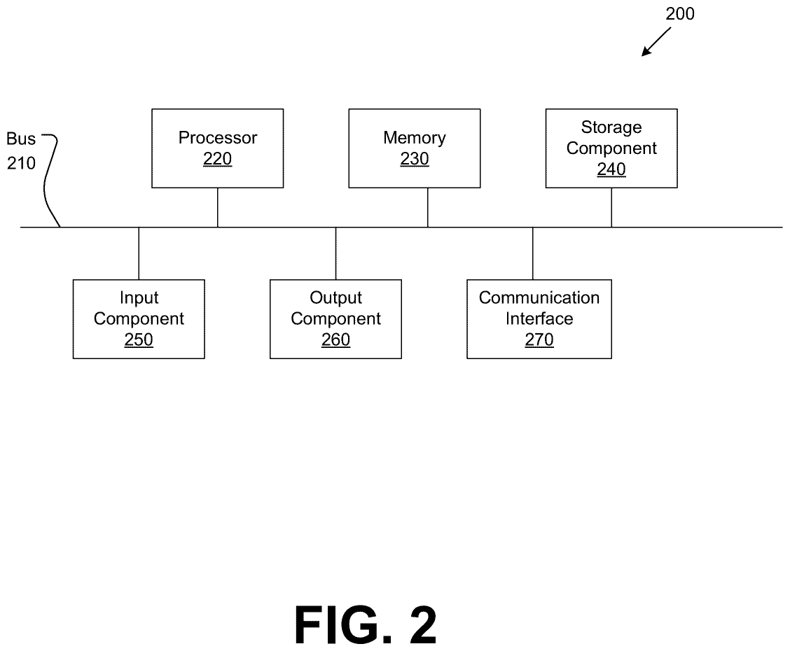

As further shown in FIG. 2, computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, and/or the like.

Application 124-1 includes one or more software applications that may be provided to or accessed by client device 210 and/or server device 140. Application 124-1 may eliminate a need to install and execute the software applications on client device 210. For example, application 124-1 may include software associated with specification platform 120 and/or any other software capable of being provided via cloud computing environment 122. In some implementations, one application 124-1 may send/receive information to/from one or more other applications 124-1, via virtual machine 124-2.

Virtual machine 124-2 includes a software implementation of a machine (e.g., a computer) that executes programs like a physical machine. Virtual machine 124-2 may be either a system virtual machine or a process virtual machine, depending upon use and degree of correspondence to any real machine by virtual machine 124-2. A system virtual machine may provide a complete system platform that supports execution of a complete operating system. A process virtual machine may execute a single program and may support a single process. In some implementations, virtual machine 124-2 may execute on behalf of a user (e.g., a user of client device 210 or an operator of specification platform 120), and may manage infrastructure of cloud computing environment 122, such as data management, synchronization, or long-duration data transfers.

Virtualized storage 124-3 includes one or more storage systems and/or one or more devices that use virtualization techniques within the storage systems or devices of computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 124-4 may provide hardware virtualization techniques that allow multiple operating systems (e.g., “guest operating systems”) to execute concurrently on a host computer, such as computing resource 124. Hypervisor 124-4 may present a virtual operating platform to the guest operating systems and may manage the execution of the guest operating systems. Multiple instances of a variety of operating systems may share virtualized hardware resources.

Computing resource 124 can also include one or more data structures associated with the specification platform 120. In an example implementation, the data structure can comprise one or more of a database, a table, a list, and/or the like. The data structure may be stored in virtualized storage (“VSs”) 124-3, or the like.

Network 130 includes one or more wired and/or wireless networks. For example, network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, an extranet, the Internet, a fiber optic-based network, and/or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 2 is a diagram of example components of a device 200. Device 200 may correspond to client device 110, specification platform 120, computing resource 124, and/or server device 140. In some implementations, client device 110, specification platform 120, and/or computing resource 124, may include one or more devices 200 and/or one or more components of device 200. As shown in FIG. 2, device 200 may include a bus 210, a processor 220, a memory 230, a storage component 240, an input component 250, an output component 260, and a communication interface 270.

Bus 210 includes a component that permits communication among the components of device 200. Processor 220 is implemented in hardware, firmware, or a combination of hardware and software. Processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 220 includes one or more processors capable of being programmed to perform a function. Memory 230 includes a random-access memory (RAM), a read only memory (ROM), and/or another type of dynamic or static storage device (e.g., a flash memory, a magnetic memory, and/or an optical memory) that stores information and/or instructions for use by processor 220.

Storage component 240 stores information and/or software related to the operation and use of device 200. For example, storage component 240 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 250 includes a component that permits device 200 to receive information, such as via user input (e.g., a touch screen display, a keyboard, a keypad, a mouse, a button, a switch, and/or a microphone). Additionally or alternatively, input component 250 may include a sensor for sensing information (e.g., a global positioning system (GPS) component, an accelerometer, a gyroscope, and/or an actuator). Output component 260 includes a component that provides output information from device 200 (e.g., a display, a speaker, and/or one or more light-emitting diodes (LEDs)).

Communication interface 270 includes a transceiver-like component (e.g., a transceiver and/or a separate receiver and transmitter) that enables device 200 to communicate with other devices, such as via a wired connection, a wireless connection, or a combination of wired and wireless connections. Communication interface 270 may permit device 200 to receive information from another device and/or provide information to another device. For example, communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

Device 200 may perform one or more processes described herein. Device 200 may perform these processes based on processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may cause processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

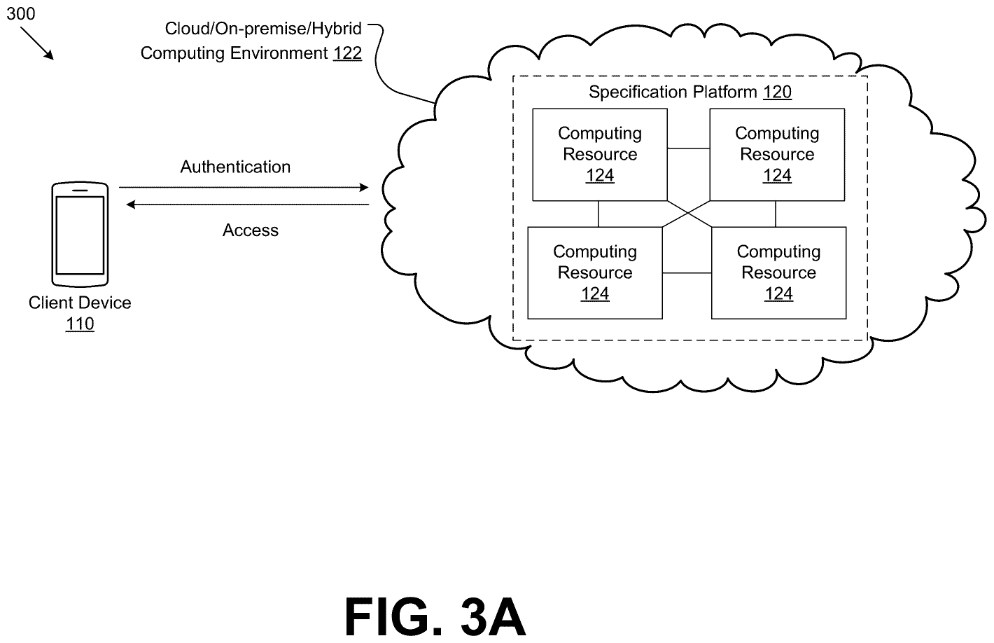

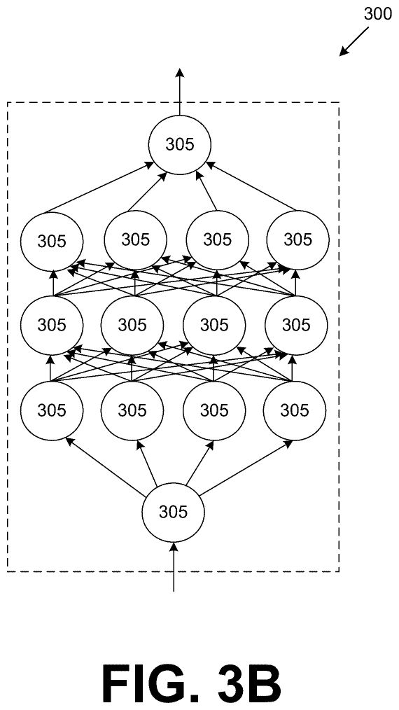

FIG. 3A illustrates an example environment 300 that includes client device 100 and specification platform 120. In this implementation, specification platform 120 provides authentication services to allow client device 110 to access computing resource(s) 124, such as APPs 124-1 or the like. The APPs 124-1 can provide users access to the various features described herein. Client device 110 may further include password managers such that the user can access third-party institution data once authenticated.

Initially, a user can create a user profile that is accessible within the environment 100. The user profile can include user profile information pertaining to the user, such as occupation, certifications, user information, projects worked on/completed, and the like. Likewise, a company may have a user profile, i.e., a company profile, that includes company profile information pertaining to the company, such as projects worked on/completed by the company, company demographics, company information and the like. As such, the user profile may be synonymous with an individual's and/or a company's resume. For example, the user profiles may represent a templated business profile and/or resume profile. The user profiles can be stored within a database structure within the VSs 124-3. In various implementations, data pertaining to the user can be stored as a graph. Within the graph context, nodes can represent users, certifications, locations, a trade group, and the like, and edges can represent relations between the various nodes. It is understood that a database structure can comprise a repository of certifications within the trade group and/or skills trade.

FIG. 3B is a diagram of an example deep neural network (DNN) 300. The DNN 300 can comprise one or more APPs 124-1 that provide functionality discussed herein to the environment 100. The DNN 300 includes multiple nodes 305, and the nodes 305 are arranged so that the DNN 300 includes an input layer, one or more hidden layers, and an output layer. Each layer of the DNN 300 can include a plurality of nodes 305. While FIG. 3B illustrates three (3) hidden layers, it is understood that the DNN 300 can include additional or fewer hidden layers. The input and output layers may also include more than one (1) node 305.

The nodes 305 are sometimes referred to as artificial neurons 305, because they are designed to emulate biological, e.g., human, neurons. A set of inputs (represented by the arrows) to each neuron 305 are each multiplied by respective weights. The weighted inputs can then be summed in an input function to provide, possibly adjusted by a bias, a net input. The net input can then be provided to activation function, which in turn provides a connected neuron 305 an output. The activation function can be a variety of suitable functions, typically selected based on empirical analysis. As illustrated by the arrows in FIG. 3B, neuron 305 outputs can then be provided for inclusion in a set of inputs to one or more neurons 305 in a next layer.

The DNN 300 can be trained to accept data as input and generate an output based on the input. The DNN 300 can be trained with ground truth data, i.e., data about a real-world condition or state. For example, the DNN 300 can be trained with ground truth data or updated with additional data by a processor. Weights can be initialized by using a Gaussian distribution, for example, and a bias for each node 305 can be set to zero.

Training the DNN 300 can including updating weights and biases via suitable techniques such as backpropagation with optimizations. Ground truth data can include, but is not limited to, data classifying and/or identifying objects within a point cloud. As discussed herein, the DNN 300 can comprise a graph neural network (GNN) that determines a similarity between request data and one or more user profiles. As briefly described above, the nodes 305 can represent users, certifications, locations, a trade group, and the like, and edges can represent relations between the various nodes 305.

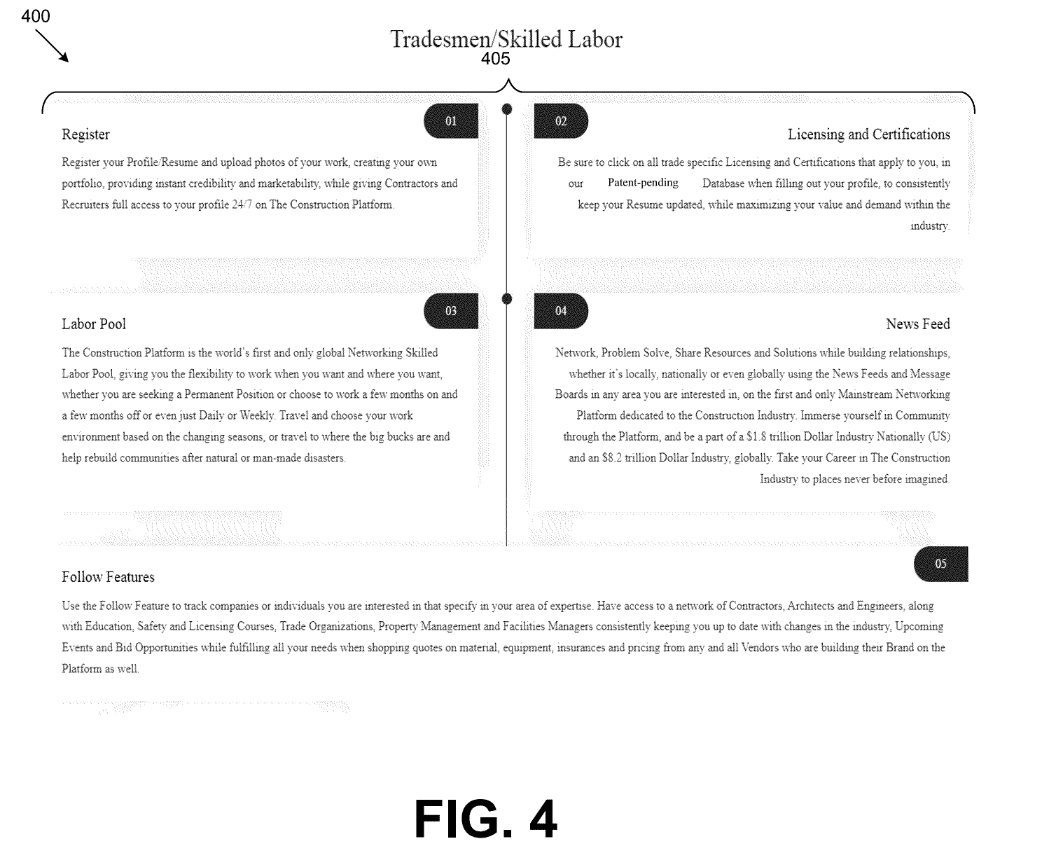

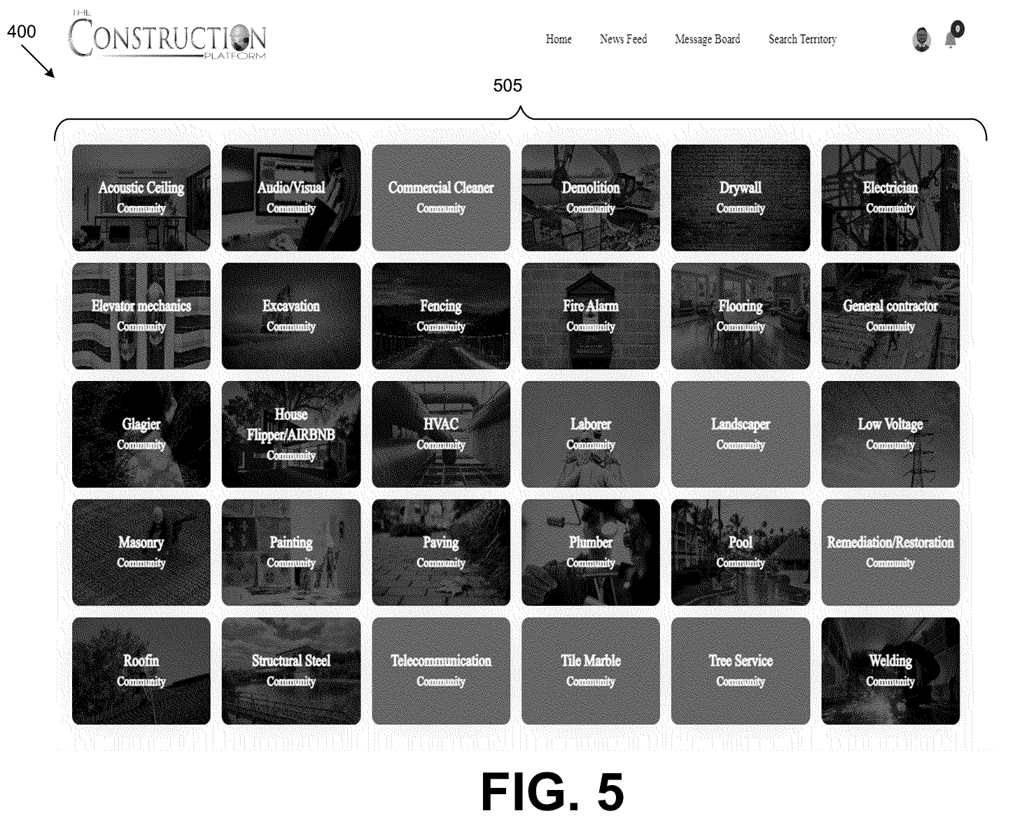

Once a user profile has been created and/or a user has been authenticated, client device 110 can access APPs 124-1. FIG. 4 illustrates an example screen 400 that includes information elements 405 for registering, uploading, accessing, and/or using the features of the APPs 124-1. FIG. 5 illustrates an example screen 500 that includes multiple tiles 505 that allows a user to associate a user profile with a specific skilled trades group, such as an acoustic ceiling community, an audio/visual community, and so forth.

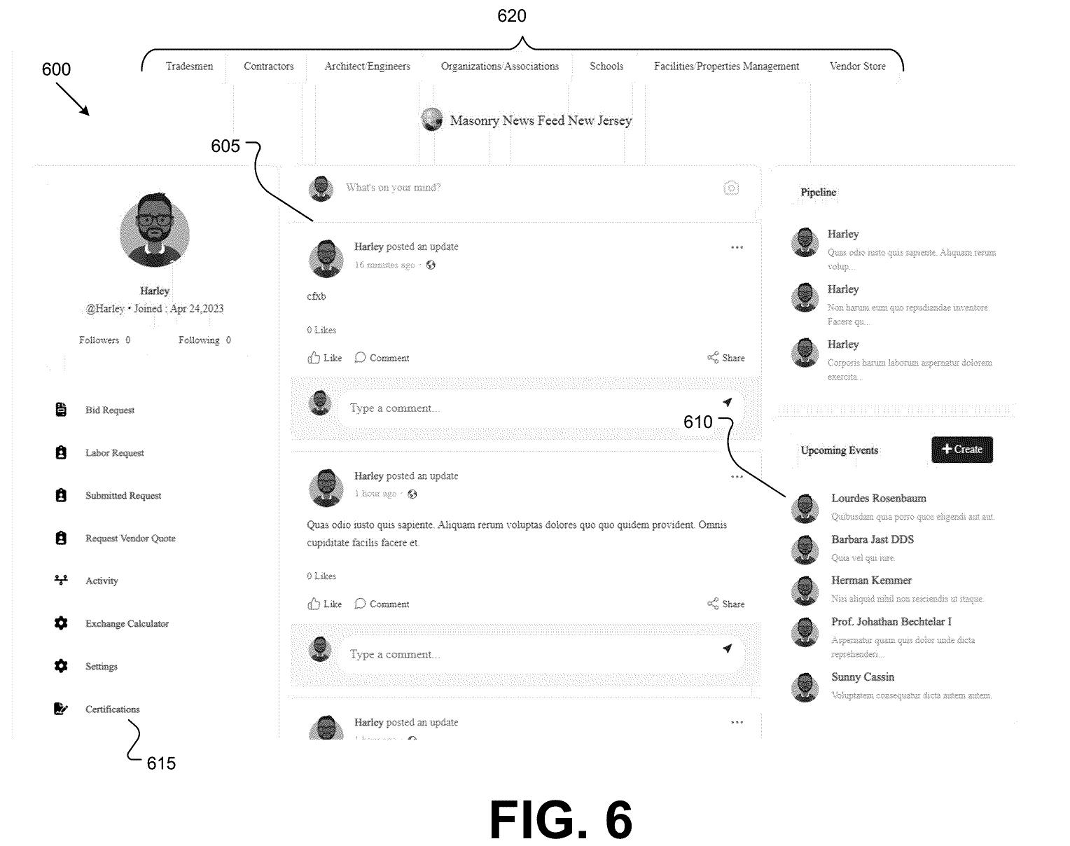

After the user selects a tile 505, the user can be presented with a news feed and/or message board 600 corresponding to the selected skilled trades group as shown in FIG. 6. The news feed 600 includes information posts 605 related to the selected trades group. In various implementations, the information posts 605 can be generated by other users of the server-client system. For example, as shown in FIG. 6, users can generate posts 605 pertaining to the masonry skills trade. The news feed 600 also includes an upcoming events section 610 that provides information pertaining to upcoming events associated with the user. The news feed 600 can also include section 615 and/or tiles 620 that allows the user to access additional features, such as webpages related to other tradesmen, contractors, architect/engineers, organizations/associations, schools, facilities/property management, and/or vendor store.

In an example implementation, a user may access an exchange calculator via section 615. The exchange calculator can allow the user to generate invoices related to services and/or projects performed, accept payments, or the like. For example, the exchange calculator may comprise application programming interfaces (APIs), for example, APIs implemented as a web service, that provide functionality to generate invoices and/or accept payments.

In an example implementation, a user may be able to access a vendor store via tiles 620. The vendor store may be webpage for a vendor and/or supplier of goods and/or services related to various trade groups. For example, a vendor and/or supplier may be a supplier of equipment, materials, parts, and/or any other services that are not performed at a project jobsite. In various implementations, the server-client communication system described herein may include industry specific vendor stores.

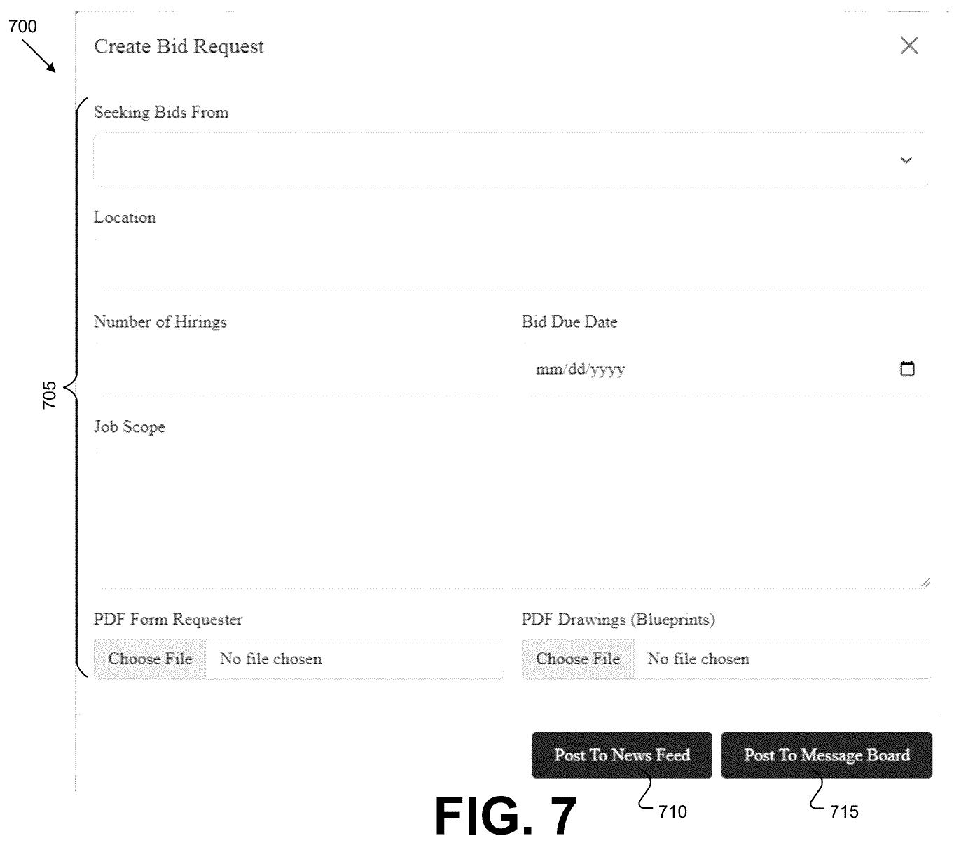

FIG. 7 illustrates an example form 700 for creating a bid request accessible via section 615. The user can input data corresponding to the bid request within various input fields 705. The input fields 705 can comprise input fields for receiving text input, for uploading data, and the like. Once finished, the user can select a button 710, 715 such that the bid request is presented to a selected trades group. In an example implementation, once the user selects a button 710, 715, the labor request can be uploaded to and presented within the news feed and/or message board 600.

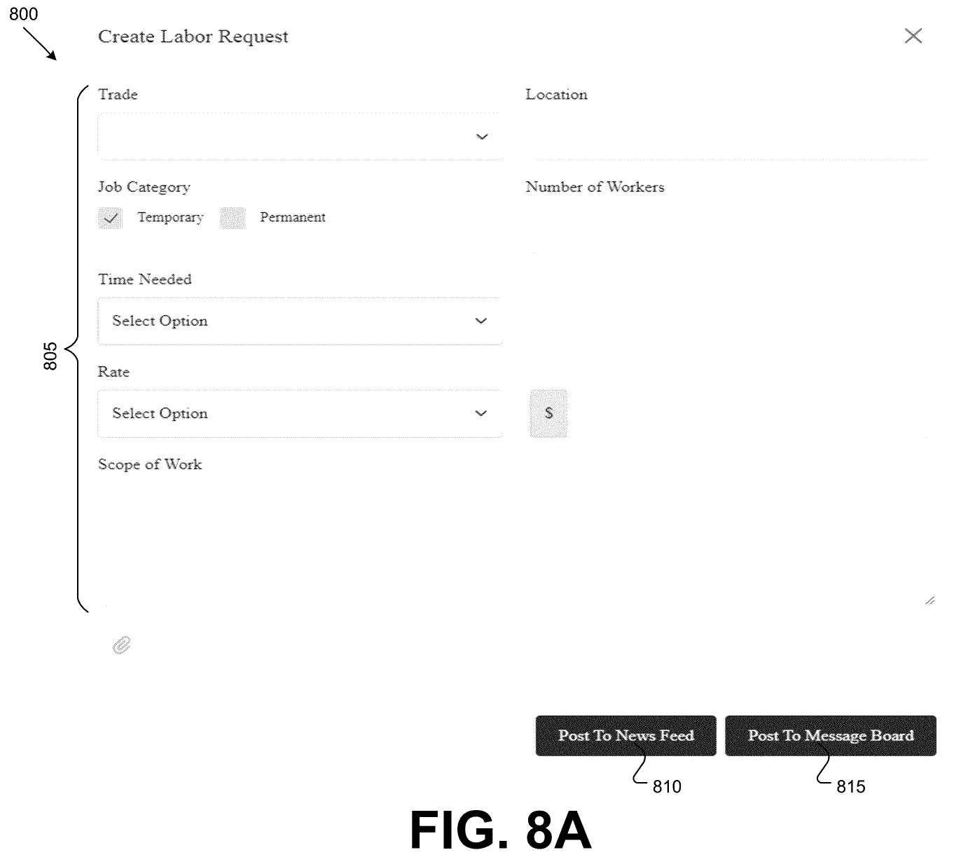

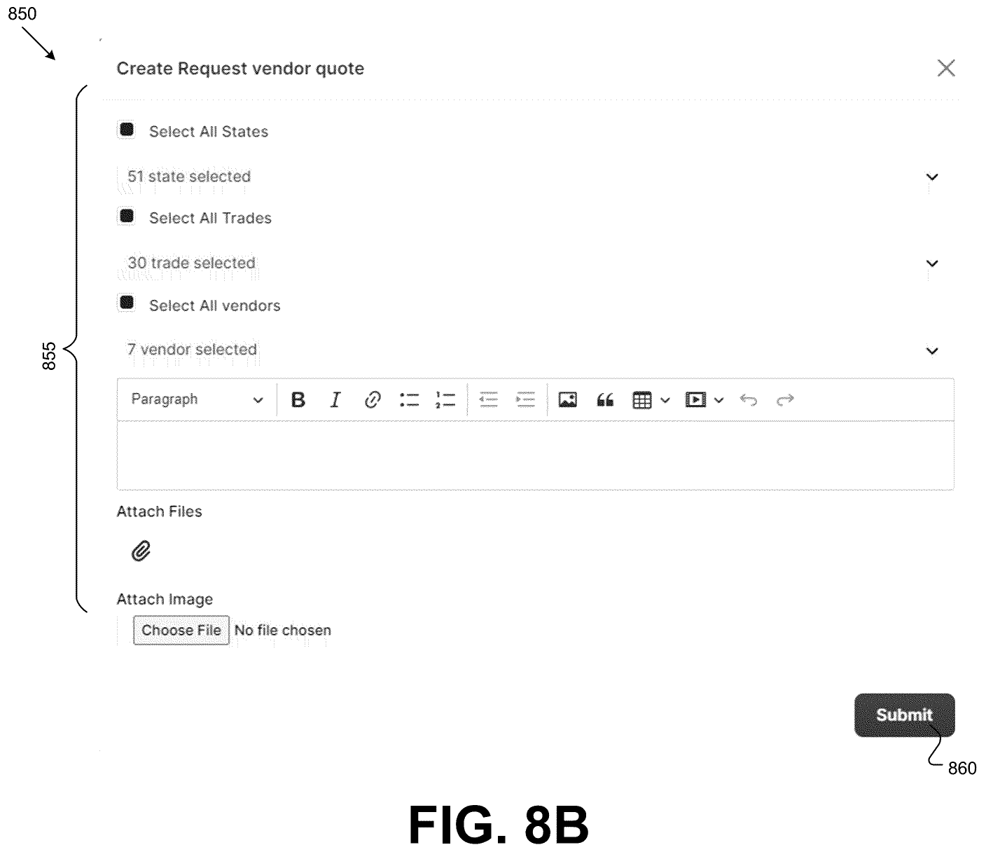

FIG. 8A illustrates an example form 800 for creating a labor request accessible via section 615. The user can input data corresponding to the labor request within various input fields 805. The input fields 805 can comprise input fields for receiving text input, for uploading data, and the like. Once finished, the user can select a button 810, 815 such that the labor request is presented to a selected trades group. In an example implementation, once the user selects a button 810, 815, the labor request can be uploaded to and presented within the news feed and/or message board 600.

FIG. 8B illustrates an example form 850 for creating a vendor quote accessible via section 615. The user can input data corresponding to a vendor quote within various input fields 855. The input fields 855 can comprise input fields for receiving text input, for uploading data, and the like. For example, the user can provide information pertaining to a project that the user would like one or more selected vendors to provide a quote for. In an example implementation, the user can provide information related to an electrical project. Based on the electrical project, the user may select one or more vendors that the user would like to submit quotes to undertake the electrical project. Once finished, the user can select a button 860 such that the vendor quote is transmitted to the selected vendors. In an example implementation, the information pertaining to the project is transmitted to an email address associated with the selected vendor profiles or the like.

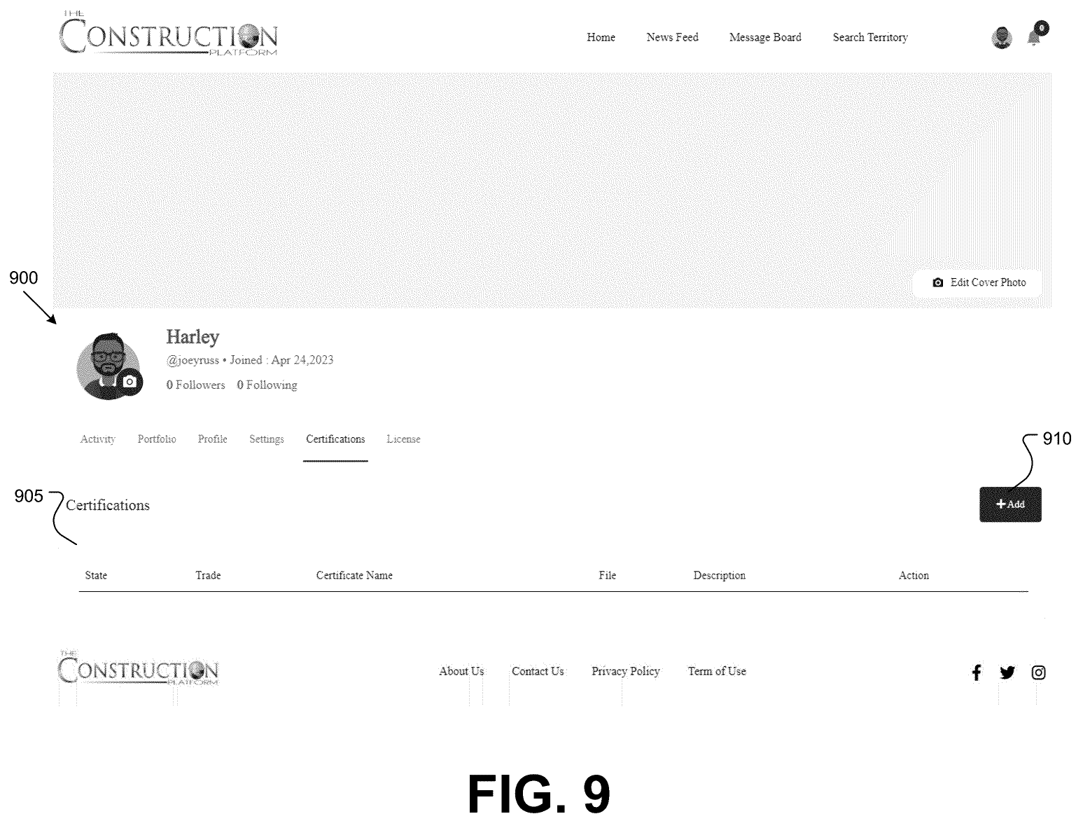

FIG. 9 illustrates an example webpage 900 for displaying certifications obtained by the user. The webpage 900 can include a certification section 905 that displays relevant information pertaining to the certification obtained by the user. Information pertaining to the user's certification can be stored within a database structure, such as a database structure stored in VSs 124-3. The database structure can map the user profile to the corresponding certifications. As shown in FIG. 9, the webpage 900 can include a button 910 that allows a user to add certification information pertaining to the user.

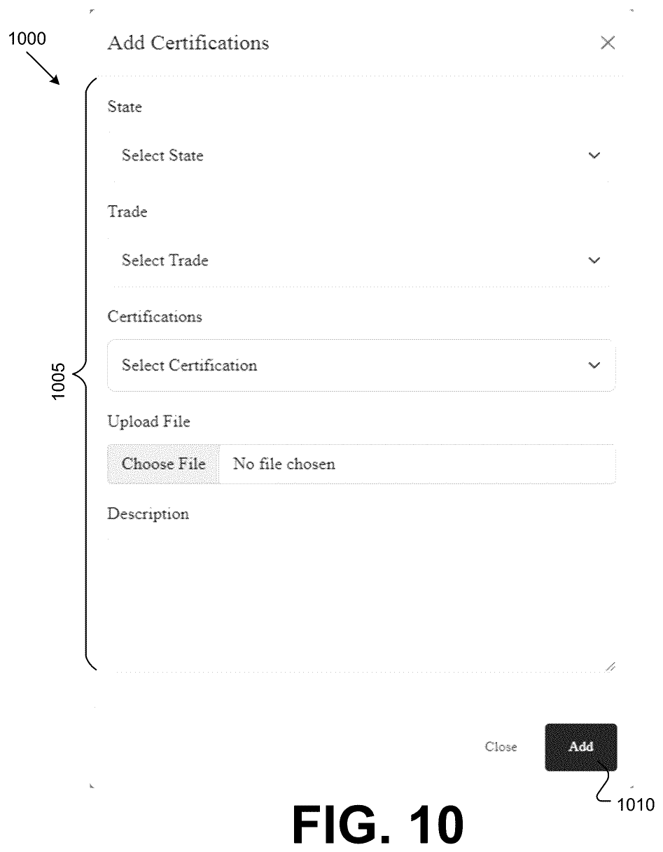

FIG. 10 illustrates an example form 1000 for adding certification information accessible via the button 910. The user can input data corresponding to the certification via various input fields 1005. The input fields 1005 can comprise input fields for receiving text input, for uploading data, and the like. Once finished, the user can select a button 1010 such that the certification is stored within a database structure and is mapped to the user profile.

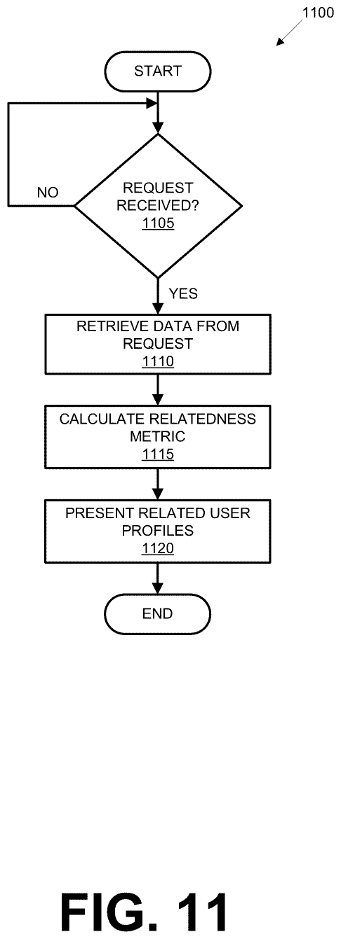

FIG. 11 is a flow chart of an example process 1100 for associating at least a first user profile with a second user profile based on a request, such as a bid request or a labor request. For example, the process 1100 can facilitate efficient allocation of resources in response to requests, such as bid requests or labor requests, submitted by users. Upon receipt of a request, the system initiates a process for identifying suitable candidates to fulfill the request based on various criteria. In some implementations, one or more process blocks of FIG. 1100 may be performed by specification platform 120.

At block 1105, a determination is made whether a request has been received. For example, the request may comprise a bid request or a labor request submitted by a first user. If a request has not been received, the process 1100 returns to block 1105. Otherwise, at block 1110, data pertaining to the request is retrieved. For example, the specification platform 120 can retrieve data corresponding to a specific trade group, a location, monetary constraints, labor constraints, or the like.

At block 1115, a relatedness metric is computed to assess the compatibility between the request data and information stored within a database structure corresponding to user profiles. This relatedness metric is calculated utilizing a graph neural network (GNN) module embedded within the specification platform 120. The GNN module (DNN 300) analyzes the request data and evaluates its similarity to one or more user profiles. In certain embodiments, the GNN module assigns differential weights to factors such as certification type and location, emphasizing their significance over monetary and labor constraints. It should be noted that these weights are adaptable based on specific constraints.

The computed similarity metric serves as a determinant for presenting a selection of user profiles to the first user. Profiles with higher calculated similarities indicate better suitability for fulfilling the request compared to those with lower similarity scores. This process aids in efficiently matching requests with users possessing the most relevant skill sets and qualifications.

At block 1120, a curated list of n user profiles is presented to the first user, where n represents an integer equal to or greater than zero (0). The presentation order is determined by the ranking derived from the relatedness metric, ensuring that profiles with higher compatibility are prioritized.

Following the completion of the process, the initiator of the bid request or labor request can proceed to select one or more user profiles from the presented options. Upon selection, the initiator and the chosen user profiles engage in commercial negotiations pertinent to the request, facilitating efficient resource allocation and task fulfillment.

The foregoing disclosure provides illustration and description, but is not intended to be exhaustive or to limit the implementations to the precise form disclosed. Modifications and variations are possible in light of the above disclosure or may be acquired from practice of the implementations.

In general, the computing systems and/or devices described may employ any of a number of computer operating systems, including, but by no means limited to, versions and/or varieties of the the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer readable medium (also referred to as a processor readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain implementations, and should in no way be construed so as to limit the claims.

Accordingly, it is to be understood that the above description is intended to be illustrative and not restrictive. Many implementations and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future implementations. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system comprising a computer including a processor and a memory, the memory including instructions such that the processor is programmed to:
receive data corresponding to at least one of a bid request or a labor request;
determine a trades group corresponding to the at least one of the bid request or the labor request; and
generate a post displaying information corresponding to the at least one of the bid request or the labor request within a news feed corresponding to the trades group.

2. The system of claim 1, wherein the processor is further programmed to receive certification information pertaining to at least one user.

3. The system of claim 2, wherein the processor is further programmed to display the certification information.

4. The system of claim 2, wherein the processor is further programmed to store the certification within a data structure that maps the certification information to the at least one user.

5. The system of claim 1, wherein the processor is further programmed to determine a relatedness metric corresponding to the at least one of the bid request or the labor request, wherein the relatedness metric comprises a similarity score between the at least one of the bid request or the labor request and another user profile.

6. The system of claim 5, wherein the processor is further programmed to use a graph neural network module to determine the relatedness metric.

7. The system of claim 6, wherein the graph neural network module weights a certification type and a location higher than monetary constraints and labor constraints.

8. A method comprising:
receiving data corresponding to at least one of a bid request or a labor request;
determining a trades group corresponding to the at least one of the bid request or the labor request; and
generating a post displaying information corresponding to the at least one of the bid request or the labor request within a news feed corresponding to the trades group.

9. The method of claim 8, further comprising receiving certification information pertaining to at least one user.

10. The method of claim 9, further comprising receiving displaying the certification information.

11. The method of claim 10, further comprising receiving storing the certification within a data structure that maps the certification information to the at least one user.

12. The method of claim 8, further comprising receiving determining a relatedness metric corresponding to the at least one of the bid request or the labor request, wherein the relatedness metric comprises a similarity score between the at least one of the bid request or the labor request and another user profile.

13. The method of claim 12, further comprising determining the relatedness metric via a graph neural network module.

14. The method of claim 13, wherein the graph neural network module weights a certification type and a location higher than monetary constraints and labor constraints.

15. A system comprising a computer including a processor and a memory, the memory including instructions such that the processor is programmed to:
receive data corresponding to at least one of a bid request or a labor request via at least one input field;
determine a trades group corresponding to the at least one of the bid request or the labor request; and
generate a post displaying information corresponding to the at least one of the bid request or the labor request within a news feed corresponding to the trades group.

16. The system of claim 15, wherein the processor is further programmed to receive certification information pertaining to at least one user.

17. The system of claim 16, wherein the processor is further programmed to display the certification information.

18. The system of claim 16, wherein the processor is further programmed to store the certification within a data structure that maps the certification information to the at least one user.

19. The system of claim 15, wherein the processor is further programmed to determine a relatedness metric corresponding to the at least one of the bid request or the labor request, wherein the relatedness metric comprises a similarity score between the at least one of the bid request or the labor request and another user profile.

20. The system of claim 19, wherein the processor is further programmed to use a graph neural network module to determine the relatedness metric.
